(19) United States
(12) Patent Application Publication
(10) Pub. No.: US 2010/0085389 A1
(43) Pub. Date: Apr. 8, 2010

(54) DISPLAY DEVICE

(76) Inventor: Ikuko YOSHIDA, Ishikawa-gun (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/570,768

(22) Filed: Sep. 30, 2009

(30) Foreign Application Priority Data
Oct. 2, 2008 (JP) 2008-257613

(51) Int. Cl. G06F 3/038; G09G 5/10

(52) U.S. Cl. 345/690; 345/213

(57) ABSTRACT

A display device includes a display section including a plurality of display pixels which are arrayed in a matrix, a driving device configured to drive the plurality of display pixels, a timing controller which controls the driving device, and a first numerical value setting device which is connected to the timing controller, and configured to store set values of a gray-level pattern which is displayed on a pixel group which is composed of the plurality of display pixels, and the timing controller including a generating device configured to generate a gray-level signal which is supplied to the driving device, based on the set values of the gray-level pattern which are obtained from the first numerical value setting device.

### CROSS-REFERENCE TO RELATED APPLICATIONS

This application is based upon and claims the benefit of priority from prior Japanese Patent Applications No. 2008-257613, filed Oct. 2, 2008, the entire contents of which are incorporated herein by reference.

### BACKGROUND OF THE INVENTION

1. Field of the Invention

The present invention relates generally to a display device, and more particularly to an active matrix display device.

2. Description of the Related Art

An active matrix display device includes a display section which is composed of a plurality of matrix-arrayed display pixels. In the display section, there are provided scanning lines which are disposed along rows of display pixels, and signal lines which are disposed along columns of display pixels. A gate driver and a source driver, which drive the plural display pixels, are disposed around the display section. The scanning lines are connected to the gate driver, and the signal lines are connected to the source driver.

A video signal, a clock signal, etc. are supplied from a timing controller to the source driver. On the basis of an external signal which is supplied from an external signal source, the timing controller outputs the video signal, clock signal, etc. to the source driver.

The video signal, which is output from the timing controller to the source driver, corresponds to a plurality of gray levels. A frame rate control (FRC) method has been proposed as a method which effects display with a high gray level by using a driver with a low gray level.

The FRC method is a method in which during a plurality of frame periods a pixel group comprising a plurality of display pixels is displayed in a predetermined pattern in which, for example, display pixels that are displayed in an (N−1) gray level and display pixels that are displayed in an N gray level are combined. Thereby, an intermediate gray level between the (N−1) gray level and the N gray level is expressed in a pseudo-manner.

For example, in the case of displaying an intermediate gray level by using signals of the (N−1) gray level and the N gray level, if the (N−1) gray level is displayed in two frame periods of four frame periods, and the N gray level is displayed in the other two frame periods, the human eye recognizes that an image in an (N−1)+ 2/4 gray level, which corresponds to an average of the four frame periods, is displayed.

If this method is used, 8-bit display, for example, can be effected in a pseudo-manner by using a driver which outputs a 6-bit signal.

Conventionally, there has been proposed a gray-level display device which effects gray-level display by the FRC method, wherein basic patterns, which express gray levels by a distribution of ON/OFF signals of the respective pixels of a pixel block, are stored in a gray-level memory, and a greater number of gray-level patterns are made usable by rotating the basic patterns (see Jpn. Pat. Appln. KOKAI Publication No. 2006-243295).

A gray-level pattern, which is used in the FRC method, needs to be created so that neither flicker nor display non-uniformity may appear. However, the appearance of flicker or non-uniformity varies depending on a selection method or a driving method at the time when selective driving is executed. Thus, in the case where a timing controller is mounted on a panel which adopts a driving method that is different from a conventional one, it is possible that the gray-level patterns which are set in the timing controller may not be used.

In the case where the gray-level patterns, which are stored in the timing controller, need to be altered, it is necessary to newly develop a timing controller itself, and this requires a cost for development and a period for development.

As described in the above-mentioned document, in the case of using the basic patterns by rotating them, gray-level patters other than the basic patterns can be used, but the number of gray-level patterns which can be used is limited. In this case, too, if the number of usable gray-level patterns is to be increased, it is necessary to newly develop a timing controller, and this requires a cost for development and a period for development.

### BRIEF SUMMARY OF THE INVENTION

According to an aspect of the present invention, there is provided a display device comprising: a display section including a plurality of display pixels which are arrayed in a matrix; a driving device configured to drive the plurality of display pixels; a timing controller which controls the driving device; and a first numerical value setting device which is connected to the timing controller, and configured to store set values of a gray-level pattern which is displayed on a pixel group which is composed of the plurality of display pixels, and the timing controller including a generating device configured to generate a gray-level signal which is supplied to the driving device, based on the set values of the gray-level pattern which are obtained from the first numerical value setting device.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows an example of the structure of a display device according to an embodiment of the present invention;

FIG. 2A is a view for explaining an example of the method of intermediate gray-level display by an FRC method;

FIG. 2B is a view for explaining an example of the method of intermediate gray-level display by the FRC method;

FIG. 2C is a view for explaining an example of the method of intermediate gray-level display by the FRC method; and

FIG. 3 is a view for explaining an example of the method of displaying intermediate gray levels between an (N−1) gray level and an N gray level by the FRC method.

### DETAILED DESCRIPTION OF THE INVENTION

A liquid crystal display device, which is a display device according to an embodiment of the present invention, will now be described with reference to the accompanying drawings. The liquid crystal display device according to the present embodiment is, for instance, a color-display-type liquid crystal display device, which includes a pair of mutually opposed electrode substrates, namely, an array substrate (not shown) and a counter-substrate (not shown), and a liquid crystal layer LQ which is held between the paired electrode substrates.

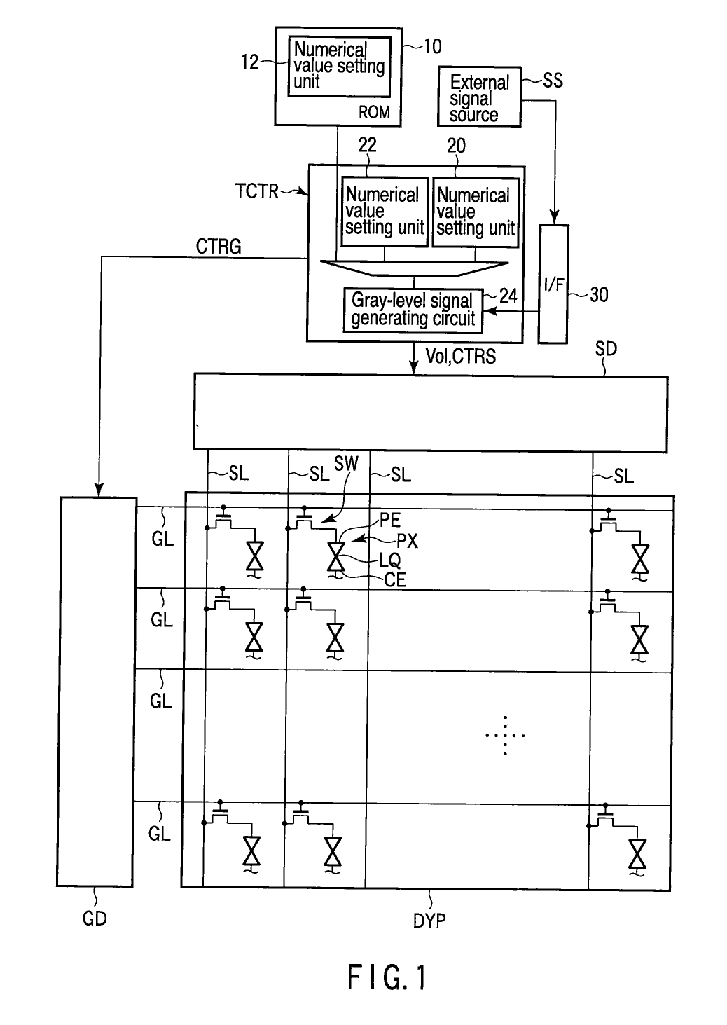

In addition, as shown in FIG. 1, the liquid crystal display device according to the present embodiment includes a display section DYP which includes a plurality of matrix-arrayed display pixels PX, a driving section which is disposed around the display section DYP and drives the plural display pixels PX, and a timing controller TCTR which controls the driving section. The driving section includes a gate driver GD and a source driver SD.

The array substrate includes, in the display section DYP, scanning lines GL1 to GLm which are disposed along rows of plural display pixels PX, and signal lines SL1 to SLn which are disposed along columns of plural display pixels PX. Pixel switches SW, which are provided in the associated display pixels PX, are disposed near intersections between the scanning lines GL1 to GLm and signal lines SL1 to SLn of the array substrate.

Each of the pixel switches SW includes, for example, a thin-film transistor as a switching element. The pixel switch SW has a gate electrode electrically connected to the associated scanning line, GL1 to GLm. The pixel switch SW has a source electrode electrically connected to the associated signal line, SL1 to SLn. The pixel switch SW has a drain electrode electrically connected to a pixel electrode PE which is disposed in the associated display pixel PX.

The gate driver GD is electrically connected to all scanning lines GL1 to GLm, and is controlled by a control signal CTRG which is supplied from the timing controller TCTR, thereby successively scanning the gate lines GL1 to GLm.

The source driver SD is electrically connected to all signal lines SL1 to SLn, and is controlled by a gray-level signal Vo1 and a control signal CTRS which are supplied from the timing controller TCTR, thereby supplying the source lines SL1 to SLn with corresponding video signals at a predetermined timing. The video signal is a signal which displays an image on the display pixel PX with a predetermined gray level corresponding to the gray-level signal Vo1.

If the scanning line, GL1 to GLm, is selected by the gate driver GD, the source-drain path of the pixel switch SW, which is connected to the selected scanning line, GL1 to GLm, is rendered conductive, and this pixel switch SW is turned on. Thus, the video signal is applied to the pixel electrode PE of the associated display pixel PX.

The counter-substrate includes a counter-electrode CE which is disposed to be opposed to the plural pixel electrodes PE. A common voltage is supplied to the counter-electrode CE. The alignment state of liquid crystal molecules, which are included in the liquid crystal layer, is controlled by a potential difference between the voltage that is applied to the pixel electrodes PE and the common voltage.

The timing controller TCTR includes numerical value setting units 20 and 22 and a gray-level signal generating circuit 24. Specifically, in the liquid crystal display device according to the present embodiment, a plurality of gray levels are expressed in the display pixel PX by the FRC method.

In the liquid crystal display device according to the present embodiment, a ROM (read-only memory) 10 is connected as a memory device to the timing controller TCTR. The ROM 10 includes a numerical value setting unit 12. Arbitrary numerical values can be input in the numerical value setting unit 12 of the ROM 10.

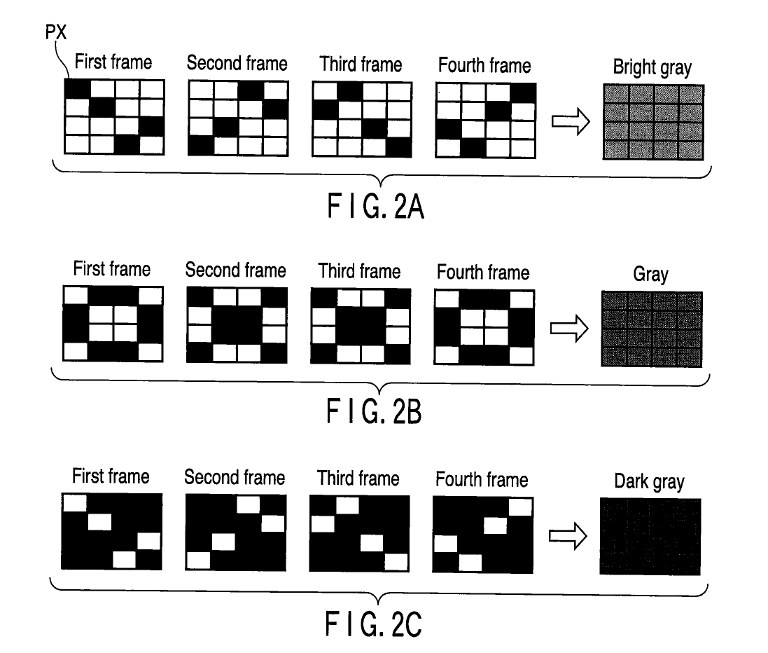

As shown in FIG. 2A to FIG. 2C, in the liquid crystal display device according to the present embodiment, the display section DYP is composed as a pixel group comprising display pixels PX of, e.g. four rows and four columns. The pixel group is caused to effect display in predetermined gray-level patterns in a plurality of frame periods, thereby displaying an intermediate gray level.

Use is made of the fact that display over plural frame periods is averaged and the averaged display is visually recognized by the human eye. In the cases shown in FIG. 2A to FIG. 2C, for example, white display or black display is effected on the display pixels PX which constitute the pixel group. Thereby, predetermined gray-level patterns are displayed over the four frame periods, and an intermediate gray level is expressed.

As shown in FIG. 2B, in each of the 16 display pixels PX that constitute the pixel group, black display is effected in two frames of the four frames, and white display is effected in the other two frames. In this case, gray display is visually recognized by the user.

As shown in FIG. 2A, in each of the display pixels PX of the pixel group, black display is effected in one frame of the four frames, and white display is effected in the other three frames. In this case, gray display, which is brighter than the gray display shown in FIG. 2B, is visually recognized by the user. The reason for this is that the four frame periods are averaged, and a time of display of white becomes longer than in the case of FIG. 2B.

As shown in FIG. 2C, in each of the display pixels PX of the pixel group, black display is effected in three frames of the four frames, and white display is effected in the other frame. In this case, gray display, which is darker than the gray display shown in FIG. 2B, is visually recognized by the user. The reason for this is that the four frame periods are averaged, and a time of display of black becomes longer than in the case of FIG. 2B.

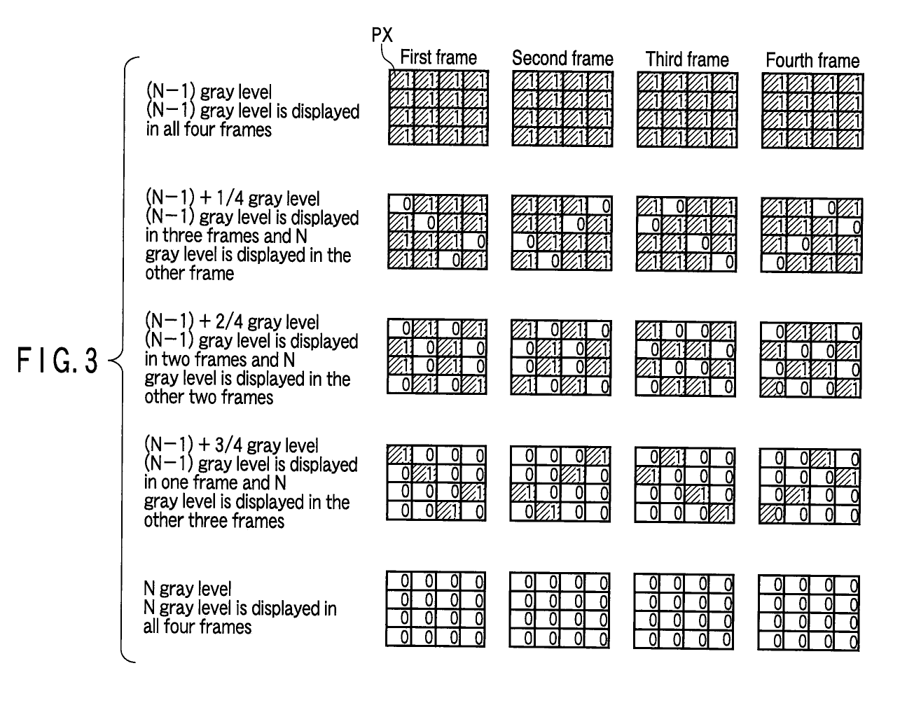

By making use of this, for example, as shown in FIG. 3, the pixel group comprising display pixels PX of four rows and four columns is caused to display predetermined gray-level patterns in four frame periods, i.e. a first frame through a fourth frame, thereby effecting display in intermediate gray levels of a ¼ gray level to a ¾ gray level between an (N−1) gray level and an N gray level.

In FIG. 3, of the display pixels PX constituting the pixel group, a display pixel PX which is marked by “1” displays an image of the (N−1) gray level, and a display pixel PX which is marked by “0” displays an image of the N gray level.

In the case of expressing the (N−1) gray level, an image of the (N−1) gray level is displayed in all display pixels PX of the four rows and four columns in the first frame through the fourth frame. In the case of expressing the N gray level, an image of the N gray level is displayed in all display pixels PX of the four rows and four columns in the first frame through the fourth frame.

In the case of expressing an (N−1)+¼ gray level, an image of the (N−1) gray level is displayed in three frames of the first frame through the fourth frame, and an image of the N gray level is displayed in the other frame. In the case shown in FIG. 3, in each of the frames, the image of the (N−1) gray level is displayed in 12 display pixels, and the image of the N gray level is displayed in the other four display pixels.

In the case of expressing an (N−1)+ 2/4 gray level, an image of the (N−1) gray level is displayed in two frames of the first frame through the fourth frame, and an image of the N gray level is displayed in the other two frames. In the case shown in FIG. 3, in each of the frames, the image of the (N−1) gray level is displayed in eight display pixels, and the image of the N gray level is displayed in the other eight display pixels.

In the case of expressing an (N−1)+¾ gray level, an image of the (N−1) gray level is displayed in one frame of the first frame through the fourth frame, and an image of the N gray level is displayed in the other three frames. In the case shown in FIG. 3, in each of the frames, the image of the (N−1) gray level is displayed in four display pixels, and the image of the N gray level is displayed in the other 12 display pixels.

In this case, 192 data, from the value (“0” or “1”) of the display pixel PX in the first row and first column of the first frame of the ¼ gray level to the value (“0” or “1”) of the display pixel PX in the fourth row and fourth column of the fourth frame of the ¾ gray level, are set in each of the numerical value setting unit 20, numerical value setting unit 22 and numerical value setting unit 12.

The data, which cause the display pixel group of the four rows and four columns to display mutually different gray-level patterns, are set in the numerical value setting unit 20, numerical value setting unit 22 and numerical value setting unit 12. The gray-level signal generating circuit 24 generates the gray-level signal Vo1, which is supplied to the source driver SD, on the basis of the set values of the gray-level patterns which are obtained from any one of the numerical value setting unit 20, numerical value setting unit 22 and numerical value setting unit 12.

The gray-level signal generating circuit 24 includes a switching device (not shown) for switching a signal that is input. The set values, which are set in any one of the numerical value setting unit 20, numerical value setting unit 22 and numerical value setting unit 12, are supplied to the gray-level signal generating circuit 24.

The switching of the input signal to the gray-level signal generating circuit 24 may be implemented by mechanical switching, for example, by operating a dial which is provided on the timing controller TCTR, or may be implemented by electrical switching by sending a control signal to the gray-level signal generating circuit 24.

It is possible to think of a plurality of combinations of set values of gray-level patterns which are displayed in four frame periods on the pixel group of the four rows and four columns. As the set values of gray-level patterns, proper set values need to be determined so as not to cause flicker or non-uniformity in an image that is displayed on the display section DYP. However, the appearance of flicker or non-uniformity varies depending on a selection method or a driving method.

Thus, in the case where the timing controller TCTR, which uses the numerical value setting of gray-level patterns similar to conventional ones, is mounted on a liquid crystal display device which adopts a selection method or a driving method that is different from a conventional one, it is possible that flicker or non-uniformity may occur. In this case, it is necessary to use numerical value setting of new gray-level patterns. The use of the numerical value setting of new gray-level patterns makes it necessary to newly develop a timing controller TCTR, and this requires a cost for development and a period for development.

By contrast, the liquid crystal display device according to the present embodiment includes the ROM 10 that is connected to the timing controller TCTR. The ROM 10 includes the numerical value setting unit 12 in which the numerical value setting of gray-level patterns is made.

By providing the ROM 10, new gray-level patterns are made usable by setting new numerical values in the numerical value setting unit 12 of the ROM 10, without the need to newly develop the timing controller TCTR itself.

Therefore, the present embodiment can provide a liquid crystal display device with high display quality regardless of the driving method, etc., wherein new gray-level patterns can be used without the need for a cost for development and a period for development.

The present invention is not limited directly to the above-described embodiment. In practice, the structural elements can be modified and embodied without departing from the spirit of the invention. In the above-described embodiment, the liquid crystal display device has been described as an example of the display device. However, the present invention is applicable to other display devices such as a plasma display and an organic EL display.

In the display device according to the above-described embodiment, 192 data are set in each of the numerical value setting unit 20, numerical value setting unit 22 and numerical value setting unit 12. However, for example, the set values of the ¼ gray level and the set values of the ¾ gray level may be interchanged between “0” and “1”, and 128 data may be set. By this setting, the number of data to be handled can be reduced, and the numerical value setting does not become complex.

Furthermore, in the display device according to the above-described embodiment, the display section DYP is composed as the pixel group comprising 16 display pixels PX of four rows and four columns, and gray-level patterns, which are displayed on the pixel group, are created. However, it should suffice if the pixel group is a combination of plural display pixels PX. If the number of display pixels PX, which constitute the pixel group, becomes larger, a greater number of gray-level patterns can be created, and flicker and non-uniformity can be prevented more effectively.

Besides, the display device according to the above-described embodiment includes the ROM 10 as the memory device that is connected to the timing controller TCTR. However, the memory device is not limited to the ROM. For example, rewritable memory means, such as a nonvolatile memory, may be used.

Various inventions can be made by properly combining the structural elements disclosed in the embodiment. For example, some structural elements may be omitted from all the structural elements disclosed in the embodiment. Furthermore, structural elements in different embodiments may properly be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display device comprising:
a display section including a plurality of display pixels which are arrayed in a matrix;
a driving device configured to drive the plurality of display pixels;
a timing controller which controls the driving device; and
a first numerical value setting device which is connected to the timing controller, and configured to store set values of a gray-level pattern which is displayed on a pixel group which is composed of the plurality of display pixels, and
the timing controller including a generating device configured to generate a gray-level signal which is supplied to the driving device, based on the set values of the gray-level pattern which are obtained from the first numerical value setting device.

2. The display device according to claim 1, wherein the timing controller includes a second numerical value setting device configured to store set values of a gray-level pattern, and a switching device configured to switch values, which are supplied to the generating device, between the set values that are set in the first numerical value setting device and the set values that are set in the second numerical value setting device.

3. The display device according to claim 1, further comprising a pair of substrates which are opposed to each other, and a liquid crystal layer which is held between the pair of substrates.

4. A display device comprising:
a display section which including a plurality of display pixels which are arrayed in a matrix;
driving means for driving the plurality of display pixels;
a timing controller which controls the driving means; and
first numerical value setting means which is connected to the timing controller, and for storing set values of a gray-level pattern which is displayed on a pixel group which is composed of the plurality of display pixels, and
the timing controller including generating means for generating a gray-level signal which is supplied to the driving means, based on the set values of the gray-level pattern which are obtained from the first numerical value setting means.
